(19) United States
(12) Patent Application Publication
(10) Pub. No.: US 2003/0165698 A1
(43) Pub. Date: Sep. 4, 2003

(54) Abrasion resistant coating compositions based on silane hydrolysates and aluminium compounds and corresponding abrasion and shock resistant coated articles

(76) Inventors: Philippe Vaneeckhoutte, Meaux (FR); Yves Leclaire, Combs la Ville (FR); Anne Robert, Creteil (FR)

Correspondence Address: FULLBRIGHT & JAWORSKI L.L.P., 600 CONGRESS AVE., SUITE 2400, AUSTIN, TX, 78701, US

(21) Appl. No.: 10/281,259

(22) Filed: Oct. 25, 2002

Related U.S. Application Data
(63) Continuation of application No. 08/681,102, filed on Jul. 22, 1996, now abandoned.
Application No. 08/681,102 is a continuation of application No. 08/205,283, filed on Mar. 2, 1994, now abandoned.

(30) Foreign Application Priority Data
Mar. 8, 1993 (FR) 93 02649

(51) Int. Cl. B32B 9/04

(52) U.S. Cl. 428/447

(57) ABSTRACT

Abrasion resistant coating compositions based on silane hydrolysates and aluminium compounds and corresponding abrasion and shock resistant coated articles

The invention relates to a hardenable composition for an abrasion resistant coating comprising the following constituents:

A—an epoxytrialkoxysilane hydrolysate,

B—a hydrolysate of a silane having formula (I)

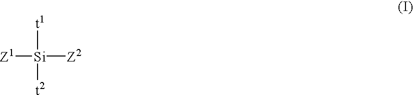

where T¹ and T² each react to give a OH group on hydrolysis and Z¹ and Z² are unreactive organic groups,

C—colloidal silica,

D—a specific aluminium catalyst,

E—optionally, an organic solvent with a boiling point between 70° C. and 140° C.;

and to corresponding coated articles, which can have non-reflective treatments.

The present invention concerns thermosetting polysiloxane compositions, in particular those obtained by hydrolysis and prepolymerisation of organofunctional alkoxysilanes which are suitable for use in coating articles of organic material, in particular ophthalmic lenses, to protect them against abrasion.

Ophthalmic lenses of transparent organic material (organic glass) are lighter than mineral glass and are now widely used.

However, a problem with organic glass is that it is more sensitive to scratching and abrasion than conventional mineral glass.

Organic glass is therefore usually protected by applying a thermally or photochemically hardenable composition to the surface to produce an abrasion resistant coating.

A known technique for producing abrasion resistant coatings consists in polymerising alkoxysilanes in the presence of aluminium derivatives.

An example of a patent concerning this technique is U.S. Pat. No. 4,211,823 which describes compositions including in a solvent medium containing more than 1% by weight of water:

a silane hydrolysate containing an epoxy group and not less than two alkoxy groups bonded directly to the silicon atom,

fine particles of silica,

certain aluminium chelates.

The composition is used to coat plastics substrates.

A problem with coatings produced from these compositions is that they render the substrate to which they are applied mechanically fragile, particularly to multidirectional shock.

In addition, the abrasion and scratch resistance of these coatings decreases very considerably when they are associated with a nonreflective coating constituted by a layer of dielectric material such as metallic oxides deposited on the surface of the abrasion resistant coating.

One object of the present invention is to provide a thermosetting polysiloxane composition containing aluminium compounds which will produce abrasion resistant coatings even when associated with a nonreflective layer and which does not render fragile the substrate to which it is applied or renders it considerably less fragile than prior art coatings.

Another object of the present invention is to provide a durable composition which produces a coating on hardening which, in addition to the above properties, has the required transparency for optical applications and good adhesion to the organic material substrate, does not crack and is preferably easily dyed.

Compositions in accordance with the invention are hardenable abrasion resistant coating compositions comprising the following constituents:

A—a silane hydrolysate containing an epoxy group and three alkoxy groups, the latter groups being directly bonded to the silicon atom,

B—a silane hydrolysate having formula (I):

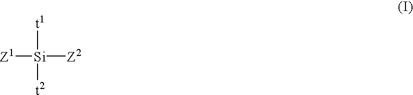

where T¹ and T² are groups which will each react to give a OH group on hydrolysis of the silane of formula (I),

Z¹ and Z² are organic groups bonded to the silicon atom by a Si—C bond which do not contain a group capable of reacting with the hydrolysed silanes present in the composition,

C—colloidal silica,

D—an aluminium compound selected from:

aluminium chelates,

compounds having formula (III) or (IV):

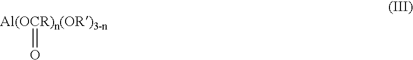

(R′O)₃₋ₙAl(OsiR″₃)ₙ (IV)

wherein:

R and R′ are linear or branched alkyl groups with 1 to 10 carbon atoms,

R″ is a linear or branched alkyl group with 1 to 10 carbon atoms, a phenyl group, a

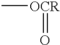

group where R has the meaning given above,

and n is a whole number from 1 to 3.

When the aluminium compound is an aluminium chelate, the composition preferably comprises

E—an organic solvent whose boiling point T at atmospheric pressure is between 70° C. and 140° C.

Constituent A of the composition is preferably an epoxysilane hydrolysate having formula (V)

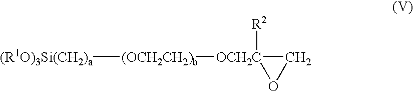

wherein:

R¹ is an alkyl group with 1 to 6 carbon atoms, preferably a methyl or ethyl group,

R² is a methyl group or a hydrogen atom,

a is a whole number from 1 to 6,

b is 0, 1 or 2.

The following are examples of such epoxysilanes: γ-glycidoxypropyltrimethoxysilane or γ-glycidoxypropyltriethoxysilane.

Preferably, γ-glycidoxypropyltrimethoxysilane is used.

It has been discovered that constituent B, in combination with constituent A, reduces the rigidity of the final coating obtained and increases the shock resistance of the corresponding coated lens, while maintaining good abrasion resistance.

Constituent B is produced from the silane of formula (I) where each of the two groups T¹ and T² bonded to the silicon is hydrolyzed to a hydroxy group so that the hydrolysed silane of formula (I) is a disilanol.

T¹ and T² are independently selected from, for example, chlorine, hydrogen and acyloxy groups or, preferably, alkoxy groups with 1 to 10 carbon atoms.

Groups Z¹ and Z² in the silane of formula (I) preferably do not contain a group which can react with the hydrolyzed silanes present in the composition, such as SiOH groups or bridging groups containing epoxy groups.

Z¹ and Z² are preferably selected independently of each other from alkyl groups with 6 to 10 carbon atoms or aryl groups with 1 to 10 carbon atoms, such as the phenyl group.

Examples of silanes of formula (I) are: dimethyldimethoxysilane, dimethyldiethoxysilane and methylphenyldimethoxysilane.

Silane hydrolysates are prepared using known methods. The techniques described in U.S. Pat. No. 4,211,823 can be employed. It is possible, for example, to mix the silanes and then hydrolyze the mixture.

It is preferable to use a stoichiometric amount of water for the hydrolysis, i.e. a molar quantity of water which corresponds to the number of moles of the groups which can produce silanols (for example Si O Alkyl, Si Cl, Si H).

Constituent C of the composition is colloidal silica, i.e. fine particles of silica with a diameter of preferably less than 50 μl in dispersion in a solvent, preferably an alcohol type solvent.

An example of such a colloidal silica is Nissan Sun Colloid Mast which contains 30% of solid SiO₂ in suspension in methanol.

Constituent D is an aluminium compound which acts as the hardening catalyst for the composition. It is selected from aluminium chelates or compounds with formulae (III) or (IV) detailed above.

An aluminium chelate is a compound formed by reacting an aluminium alcoholate or acylate with nitrogen- and sulphur-free sequestrating agents which contain oxygen as the coordinating atom.

The aluminium chelate is preferably selected from compounds having formula (II):

AlXᵥY₃₋ᵥ (II)

wherein X is an OL group where L is an alkyl group with 1 to 10 carbon atoms,

Y is at least one coordinating product obtained from a compound having formula (1) or (2)

M¹COCH₂COM² (1)

M³COCH₂COOM⁴ (2)

wherein:

M¹, M², M³ and M⁴ are alkyl groups with 1 to 10 carbon atoms,

and v takes the value 0, 1 or 2.

Examples of compounds having formula (II) are aluminium acetylacetonate, aluminium ethylacetoacetate bisacetylacetonate, aluminium bisethylacetoacetate acetylacetonate, aluminium di-n-butoxide monoethylacetoacetate and aluminium diisopropoxide monomethylacetoacetate.

Preferred compounds having formula (III) or (IV) are those where R′ is an isopropyl or ethyl group and R and R″ are methyl groups.

One or more compounds having formula (II), (III) or (IV) can be used as constituent D.

Constituent D is used in proportions which will harden the compositions of the invention over a period of a few hours at temperatures in the order of 100° C.

It is generally used in a proportion of 0.1% to 5% by weight of the total composition weight.

When constituent D is an aluminium chelate the composition preferably comprises a constituent E which is an organic solvent whose boiling point T at atmospheric pressure is between 70° C. and 140° C.

Constituent E is preferably used when constituent D is an aluminium chelate and can be used when constituent D is selected from aluminium compounds having formula (III) or (IV).

Ethanol, isopropanol, ethyl acetate, methylethylketone or tetrahydropyrane can be used as constituent E.

Compositions in accordance with the invention can also comprise other organic solvents (apart from constituent E), preferably alcohol type solvents such as methanol, which serve to adjust the viscosity of the composition.

The following proportions by weight are used for the composition constituents:

130 to 230 parts of constituent A,

20 to 150 parts of constituent B,

30 to 800 parts of constituent C, preferentially 200 to 800 parts,

5 to 20 parts of constituent D,

20 to 50 parts of constituent E, when present.

In general, compositions with a theoretical dry content of 5% to 20% by weight of solid material from constituent B, preferably 8% to 16% by weight, and optimally 10% to 15% by weight are preferred.

Compositions in accordance with the invention which have the best properties are those containing at least 40%, preferably in the order of 50%, of solid material (SiO₂) from constituent C in the theoretical dry content.

The expression “weight of solid material from constituents A or B” means the calculated weight of unit QₖSiO_{(4-k)/2} where Q is an organic group which is directly handed to a silicon atom by a Si—C bond and QₖSiO_{(4-k)/2} comes from QₖSiR″′₍₄₋ₖ₎ where Si—R″′ reacts to form SiOH of hydrolysis and k is 0, 1 or 2.

The expression weight of solid material from constituent C″ moans the weight of SiO₂.

The theoretical dry content (TDC) is the total calculated weight of solid material from constituents A, B and C, with the addition of the weight of constituent D.

Compositions in accordance with the invention preferably comprise at least 1% by weight of water.

The water can be the result of incomplete hydrolysis of the starting silanes or of the condensation reaction of the silanols formed during the hydrolysis.

The water can also be added to the composition either directly or by means of the organic solvents which contain a certain percentage of water.

The compositions can also include various additives, such as surfactants to improve spreading of the composition over the surface to be coated, UV absorbers or pigments.

Coated articles in accordance with the invention are organic material articles, particularly those used in ophthalmics and especially an organic material obtained by polymerisation of diethylene glycol di(allylcarbonate) or bis phenol A di(allylcarbonate).

The compositions may be applied using any appropriate known technique such as dipping and centrifuging.

They are then thermally hardened at a temperature ranging from 60° C. to 200° C.

The thickness of the hardened coatings is ranging from 1 to 20 μm, preferentially from 1 to 5 μm.

Following hardening of the composition, a nonreflective coating may be formed on the surface of the abrasion resistant coating.

A nonreflective coating is constituted by a mono- or multilayered film of dielectric material such as SiO, SiO₂, Si₃N₄, TiO₂, ZrO₂, Al₂O₃ or MgF₂ or mixtures thereof, by vacuum deposition or ionic spraying. It is thus possible to prevent reflections at the lens-air interface. When the film comprises a single layer, its optical thickness must equal λ/4 where λ is a wavelength between 450 nm and 650 nm.

When a multilayer film comprising three layers is used, a combination corresponding to respective optical thicknesses of λ/4-λ/2-λ/4 or λ/4-λ/4-λ/4 can be used.

An equivalent film formed of more than two layers can also be used in place of any one of the three layers mentioned above.

One of the objects of the invention is thus to provide an organic material article bearing an abrasion resistant coating as described above which is itself coated with at least one nonreflective layer.

The following examples serve to illustrate the invention in more detail without limiting its scope.

The properties of the coated lenses produced in the examples were estimated by measurement of:

Abrasion resistance, using the value obtained from the BAYER test carried out in accordance with standard ASTM F735.81.

A high value in the BAYER test corresponds to a high degree of abrasion resistance.

Scratch resistance using a steel wool test.

Extra fine n° 000 STARWAX steel wool was used.

A piece of steel wool about 3 cm by 3 cm was folded on itself and used to make 10 to-and-fro rubbing movements on the coated lens in the fibre direction using a constant pressure throughout the operation.

The lens was then rubbed with a dry cloth and rinsed with alcohol.

The state of the lens was then estimated and classified as follows:

| | |
|---|---|
| 0 | no observed scratching, |
| 1 | lens very slightly scratched (0 to 5 |
| | scratches), |
| 2 | lens slightly scratched (up to 20 scratches), |
| 3 | lens somewhat scratched (up to 50 scratches), |
| 4 | lens very scratched (more than 50 scratches), |
| 5 | bare substrate (ORMA ®). |

Shock resistance using a ball bearing drop test.

Ball bearings were dropped onto the centre of a coated lens at increasing energies until starring or breakage of the lens.

An average rupture energy was then calculated for the coated lens.

Appearance of the coated lens, judged by visual inspection.

Classification was as follows:

good for a transparent lens showing no imperfections,

acceptable for a very slightly diffusing lens,

unsatisfactory for a lens which is diffusing or exhibits surface imperfections.

Coating adherence:

An adherence test was carried out in accordance with standard AFNOR 76 FNT 30-038 which classifies results from degree zero through degree five.

The test consisted in cutting the coating with a cutter into a crosshatched grid, applying adhesive tape to the cut coating and attempting to tear it off with the tape.

A result is considered good if of degree zero i.e. if the cut edges remain perfectly smooth and none of the cut squares becomes detached even after the coated lens has been left in a boiling water bath for 30 minutes.

Proportions, percentages and quantities mentioned in the examples are proportions, percentages and quantities by weight unless otherwise indicated.

γ-glycidoxypropyltrimethoxysilane is abbreviated to GLYMO.

Dimethyldiethoxysilane is abbreviated to DMDES.

TDC signifies the theoretical dry content.

The thickness of the hardened polysiloxanic coatings, in the examples, is comprised between 2 and 5 μm.

### EXAMPLE 1

40.85 parts of 0.1N hydrochloric acid wire added dropwise to a solution containing 152.6 parts of GLYMO and 24.5 parts of DMDES.

The hydrolysed solution was stirred for 24 hours at room temperature then 400 parts of 30% colloidal silica in methanol, 150 parts of methanol, 10 parts of aluminium acetylacetonate and 29.8 parts of ethylcellosolve were added.

A small amount of surfactant was added to the composition to improve its spreading properties.

The theoretical dry content (TDC) of the composition was in the order of 5% of sold material from the hydrolysed DMDES.

ORMA® ophthalmic lenses of organic glass constituted by a diethylene glycol di(allylcarbonate) polymer with a central thickness of 2 mm were dip coated and then precured for 15 minutes at 60° C. They were then placed in an oven at 100° C. for three hours.

### EXAMPLE 2

42.9 parts of 0.1N hydrochloric acid were added dropwise to a solution containing 135.7 parts of GLYMO and 49 parts of DMDES.

The hydrolysed solution was stirred for 24 hours at room temperature and then 8.8 parts of aluminium acetylacetonate, 26.5 parts of ethylcellosolve, 400 parts of 30% colloidal silica in methanol and 157 parts of methanol were added.

A small amount of surfactant was added.

The TDC of the composition was in the order of 10% of solid material from the hydrolysed DMDES.

The composition was applied to an ORMA® lens with a central thickness of 2 mm which was then treated as described in example 1.

### EXAMPLE 3

80.5 parts of 0.1N hydrochloric acid were added dropwise to a solution containing 224 parts of GLYMO and 120 parts of DMDES.

The hydrolysed solution was stirred for 24 hours at room temperature and then 718 parts of 30% colloidal silica in methanol, 15 parts of aluminium acetylacetonate and 44 parts of ethylcellosolve were added.

A small amount of surfactant was added.

The TDC of the composition was in the order of 13% of solid material from the hydrolyzed DMDES.

The composition was applied to an ORMA® lens with a central thickness of 2 mm and then treated as described in example 1.

### EXAMPLE 4

Example 2 was repeated using 100 g of GLYMO and 96 g of DMDES.

The TDC of the composition was in the order of 20% of solid material from hydrolyzed DMDES.

### EXAMPLE 5 (COMPARATIVE)

39 parts of 0.1N hydrochloric acid were added dropwise to 170 parts of GLYMO.

The hydrolysed solution was stirred for 24 hours at room temperature and then 400 parts of 30% colloidal silica in methanol, 11 parts of aluminium acetylacetonate, 33 parts of ethylcellosolve and 147 parts of methanol were added.

The coated lenses of examples 1 to 5 were tested and the results are shown in table I.

The results obtained for an uncoated ORMA® lens are given for reference.

TABLE I

| | Ex 1 | Ex 2 | Ex 3 | Ex 4 | Ex 5 | Ref |
|---|---|---|---|---|---|---|
| Steel wool | 0-0.5 | 0 | 0 | 0.5-1 | 0 | 5 |
| Ball bearing | 500 | 569 | 687 | 559 | 383 | — |
| drop test | | | | | | |
| (E rupture in mJ) | | | | | | |
| Appearance | good | good | good | acceptable | good | good |

| | |
|---|---|
| Adherence | good |

### EXAMPLES 6 TO 9

Each of the coated lenses obtained from examples 1 to 4 was given a non-reflective coating.

The coating compositions of examples 6 to 9 correspond respectively to those of examples 1 to 4.

The lenses were given a non-reflective coating by vacuum deposition of a multilayer titanium oxide and silicon based film using an evaporation technique. The net film thickness was in the order of 250 nm.

The nonreflecting lenses were tested and the results are shown in Table II.

TABLE II

| | Ex 6 | Ex 7 | Ex 8 | Ex 9 |
|---|---|---|---|---|
| Composition | 1 | 2 | 3 | 4 |
| corresponding to | | | | |
| example number | | | | |
| Steel wool | 0.5-1 | 0.5-1 | 0.5-1 | 0.5-1.5 |
| BAYER | 2.3 | 2.9 | 3.3 | 2.5 |
| Appearance | good | good | good | acceptable |

| | |
|---|---|
| Adherence | good |

### EXAMPLE 10

117.6 parts of 0.1N hydrochloric acid was added dropwise to a mixture of 330.4 parts of GLYMO and 172.8 parts of DMDES.

The hydrolyzed solution was stirred for 24 hours at room temperature and than 1 066.7 parts of 30% colloidal silica in methanol and 100 parts of methylethylketone were added.

A small amount of surfactant was added (1.6 parts by weight).

The composition obtained was divided into two equal fractions: fraction 1 and fraction 2.

Fraction 2 was to be used as described in example 11.

10.74 parts of aluminum acetylacetonate were added to fraction 1. The composition was then filtered and applied to an ORMA® lens having a central thickness of 2 mm. It was then treated as described in example 1.

The rupture energy of a lens coated in this fashion was 540 mJ.

### EXAMPLE 11

3.38 parts of Al(OiPr)₃ were dissolved in 20 parts of toluene and one part of acetic acid added to produce in situ

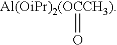

The mixture was added to fraction 2 of example 10.

The composition obtained was applied to an ORMA® lens having a central thickness of 2 mm and then treated as described in example 1.

The rupture energy of a lens coated in this fashion was 651 mJ.

1. Hardenable composition for an abrasion resistant coating comprising the following constituents:
A—a silane hydrolysate containing an epoxy group and three alkoxy groups, the latter groups being directly bonded to the silicon atom,
B—a silane hydrolysate having formula (I): 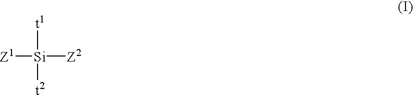
where T¹ and T² are groups which will each react to give a OH group on hydrolysis of the silane of formula (I),
Z¹ and Z² are organic groups bonded to the silicon atom by a Si—C bond which do not contain a group capable of reacting with the hydrolysed silanes present in the composition,
C—colloidal silica,
D—an aluminium compound selected from:
aluminium chelates,
compounds having formulated (III) or (IV) 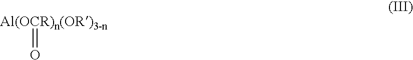
(R′O)₃₋ₙAl(OSiR″₃)ₙ (IV)
wherein:
R and R′ are linear or branched alkyl groups with 1 to 10 carbon atoms,
R″ is a linear or branched alkyl group with 1 to 10 carbon atoms, a phenyl group, a 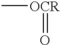
group where R has the meaning given above, and n is a whole number from 1 to 3.

2. Composition according to claim 1 characterised in that it further comprises, when the aluminium compound is an aluminium chelate:
E—an organic solvent whose boiling point T at atmospheric pressure is between 70° C. and 140° C.

3. Composition according to claim 1 or claim 2 characterised in that the silane containing an epoxy group has the following formula (V) 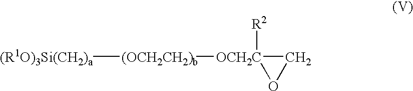
wherein:
R¹ is an alkyl group with 1 to 6 carbon atoms, preferably a methyl or ethyl group,
R² is a methyl group or hydrogen atom,
a is a whole number from 1 to 6,
b is 0, 1 or 2.

4. Composition according to claim 3 characterised in that the silane having formula (V) is γ-glycidoxypropyltrimethoxysilane.

5. Composition according to any one of the preceding claims characterised in that in formula (I) of constituent B:
T¹ and T² are alkoxy groups with 1 to 10 carbon atoms, and
Z¹ and Z² are selected from alkyl groups with 1 to 10 carbon atoms and aryl groups with 6 to 10 carbon atoms, such as the phenyl group.

6. Composition according to claim 5 characterised in that the silane of formula (I) is selected from dimethyldimethoxysilane, dimethyldiethoxysilane and methylphenyldimethoxysilane.

7. Composition according to any one of the preceding claims characterised in that it further comprises an alcohol type solvent.

8. Composition according to any one of the preceding claims characterised in that the following proportions by weight are employed for the constituents A, B, C, D and E in the composition:
130 to 230 parts of constituent A,
20 to 150 parts of constituent B,
200 to 600 parts of constituent C,
5 to 20 parts of constituent D,
optionally, 20 to 50 parts of constituent E,

9. Composition according to any one of the preceding claims characterised in that it contains at least 1% by weight of water.

10. Composition according to any one of the preceding claims characterised in that the theoretical dry content of the composition is 5% to 20% by weight of solid material from constituent B.

11. Composition according to claim 10 characterised in that said theoretical dry content is 8% to 16% by weight of solid material from constituent B.

12. Composition according to claim 11 characterized in that said theoretical dry content is 10% to 15% by weight of solid material from constituent B.

13. Organic material article bearing an abrasion resistant coating produced by hardening a composition according to any one of the preceding claims.

14. Coated article according to claim 13 characterised in that said article comprises a diethylene glycol di(allylcarbonate) polymer.

15. Coated article according to claim 13 or claim 14 characterised in that it is in the form of an ophthalmic lens.

16. Coated article according to claim 15 characterised in that it comprises at least one nonreflective coating on the surface of the abrasion resistant coating.

17. Coated article according to claim 16 characterised in that the nonreflective coating is constituted by a mono- or multilayer film of metallic oxides.
